(19) United States
(12) Patent Application Publication
(10) Pub. No.: US 2007/0104982 A1
(43) Pub. Date: May 10, 2007

(54) Method of operating fuel cell

(75) Inventor: Gang Xie, Aichi-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi, Aichi-ken (JP)

(21) Appl. No.: 10/563,872

(22) PCT Filed: Jul. 13, 2004
(86) PCT No.: PCT/JP04/10285

§ 371 Date: Jan. 9, 2006

(30) Foreign Application Priority Data
Jul. 15, 2003 (JP) 2003-274819

(51) Int. Cl. H01M 8/00; H01M 8/10

(52) U.S. Cl. 429/13; 429/30

(57) ABSTRACT

A method for operating a fuel cell, which is capable of recovering the performance of the fuel cell when the performance of the fuel cell is degraded. The fuel cell includes a membrane electrode assembly having an electrolyte film, an anode, and a cathode. The anode and the cathode sandwich the electrolyte film and carry a catalyst metal. An oxidizing agent is fed to the cathode and fuel is fed to the anode to generate power. After a predetermined period of time has passed, two sides of the membrane electrode assembly are inverted to carry out a changing operation of changing the anode before inverted to a cathode, and changing the cathode before inverted to an anode. After the changing operation, an oxidizing agent is fed to the cathode after changed and fuel is fed to the anode after changed, thereby starting a power generation again.

### TECHNICAL FIELD

The present invention relates to a method for operating a fuel cell, which is favorable to keep a high output.

### BACKGROUND ART

The performance of a fuel cell is gradually degraded with time. Conventionally, before the normal operation of the fuel cell, there has been carried out the method of supplying an electric current with a higher current density than a predetermined current density to enhance the output of the fuel cell, which is called the accustomed operation. The accustomed operation intends to wet an electrolyte film at the beginning of the operation of the fuel cell. By carrying out the accustomed operation using a pure oxygen gas as an oxidizing agent to be fed to a cathode with a current density as great as possible and for a period as long as possible, the cell voltage can be remarkably enhanced.

However, the above-described accustomed method requires a long operation time and is carried out with a great electric current so that the electrolyte film may be damaged due to “flooding” and a large amount of heat generation, which are caused by the great electric current operation. The “flooding” means that gas feeding passes in cathodes are clogged with water formed therein. Because of such disadvantage, it is not clear that the characteristic ability of the fuel cell can be effectively achieved with the above-described method.

In Patent document 1, there is noticed that when metallic ions from components of the fuel cell, and metallic ions in the air are trapped with an electrolyte film, the ionic conduction of the electrolyte film lowers to degrade the power generation performance, and disclosed a method for removing the metallic ions from the electrolyte film and recovering the deterioration of the fuel cell by bringing a fluid for recovering the deterioration, which contains a reducing agent exhibiting a stronger reducing power than hydrogen gas, into contact with the electrolyte film.

And in Patent document 2, there is disclosed a technique of forming a chelating complex with metallic ions in the electrolyte film using a chelating agent instead of the strong reducing agent, and extracting the chelating complex out of the electrolyte film to remove the metallic ions from the electrolyte film.

And in Patent document 3, there is disclosed a technique of applying a load with a high current density to remove impurity ions accumulated within a cell from an electrolyte and discharging them out of the cell along with water resulted from the electrode reaction, a technique of interchanging gases fed to a fuel electrode and an air electrode with each other to reverse the direction of an electric current, moving the impurity ions in a reverse direction, and discharging them out of the cell, and a technique of cleaning the impurity ions with an acid liquid and discharging them out of the cell after replaced with hydrogen ions.

Patent document 1: Publication of unexamined JP patent application No. 2000-260453

Patent document 2: Publication of unexamined JP patent application No. 2000-260455

Patent document 3: Publication of unexamined JP patent application No. 2003-123812.

### DISCLOSURE OF THE INVENTION

With these methods, however, a long period of time is required, and only one reason for the degradation of the performance is merely removed. It has been known from the below-mentioned experimental results of the present inventor that whether oxides or hydroxides of platinum, or other impurities, which have been formed on surfaces of platinum particles as a catalyst metal, can be reduced while producing the fuel cell or leaving the same quiet is a greatly influencing point against the activation of the fuel cell, as compared with the technique of wetting the electrolyte film. Accordingly, it is doubtful whether the characteristic ability of the fuel cell can be entirely effected merely with the above-described techniques of the patent documents.

The present invention has been made in view of these circumstances, and has an object of providing a method for operating a fuel cell, which intends to recover the performance of the fuel cell when degraded.

The present inventor has continuously analyzed the activation of the fuel cell with an electrochemical AC impedance method using a polymer electrolyte fuel cell composed of a plurality of membrane electrode assemblies, each having an electrolyte film, an anode and a cathode for sandwiching the electrolyte film and carrying a catalyst metal, respectively, and an impedance analyzer which is also called “frequency response analyzer”. As a result of analysis, the present inventor has found that the wetting effect of the electrolyte film is effective in the activation treatment, but, only the wetting effect is not sufficient, and that it is favorable for recovering the cathode which has been deteriorated due to the power generation reaction to lower the potential of the cathode as low as possible upon activation, namely to bring the potential of the cathode to about 0 volt as a standard electrode potential of the oxidation and reduction of hydrogen.

It has not been sufficiently clarified why the potential of the cathode is readily recovered by lowering the potential of the cathode as low as possible, but it can be considered as follows from the impedance analysis. Namely, it can be considered that the oxidation of the catalyst metal itself or the adsorption of other strong adsorbed species, which occurs on surfaces of the catalyst metal in the cathode while the power generation of the fuel cell is operated or stopped, is a great reason for the degradation of the performance of the fuel cell. Accordingly, by artificially determining the potential of the cathode to 0.5 volt or less (about 0 volt, ex.) at regular or irregular intervals, the oxides or adsorbed species can be continuously removed from the surfaces of the cathode, the peculiar reaction activity of the catalyst metal in the electrode as the cathode can be held and recovered, and the performance of the fuel cell can be prevented from being degraded, or the degraded performance can be recovered.

Accordingly, based on the above-described viewpoint, the present inventor has noticed that, during the power generation reaction, the potential of the cathode is high, but the potential of the anode is low (about 0 volt), and has found that for lowering the potential of the cathode which has been deteriorated due to the power generation reaction, it is effective to generate power by feeding an oxidizing agent to the cathode while feeding fuel to the anode, carry out the operation of changing the anode to a cathode and changing the cathode to an anode after a predetermined period of time has passed, and restart the power generation by feeding an oxidizing agent to the cathode after changed while feeding fuel to the anode after changed.

The term “cathode after changed” means the cathode resulted from the operation of changing the anode to a cathode and changing the cathode to an anode. And the term “anode after changed” means the anode resulted from the operation of changing the anode to a cathode and changing the cathode to an anode.

In particular, the present inventor has found that the following (1) through (3) are effective, and has developed the present invention based on these findings.

(1) Two sides of the membrane electrode assembly are inverted to change the anode before inverted to a cathode and change the cathode before inverted to an anode, and the power generation is restarted in the changed state of electrodes.

(2) Two sides of a cell module for mounting the membrane electrode assembly are inverted to invert two sides of the membrane electrode assembly. Consequently, the anode before inverted is changed to a cathode and the cathode before inverted is changed to an anode. And the power generation is restarted in the changed state of electrodes.

(3) By carrying out the changing operation of interchanging the oxidizing agent and the fuel fed to the anode and the cathode with each other, the anode before the changing operation can be changed to a cathode, and the cathode before the changing operation can be changed to an anode. And the power generation is restarted in the changed state of electrodes.

(1A) In accordance with a first invention, the method for operating a fuel cell which is provided with a membrane electrode assembly having an electrolyte film, an anode and a cathode, wherein the anode and the cathode sandwich the electrolyte film and carry a catalyst metal, respectively, is characterized in that an oxidizing agent is fed to the cathode and fuel is fed to the anode to generate power, two sides of the membrane electrode assembly are inverted after a predetermined period of time has passed, thereby carrying out the changing operation of changing the anode before inverted to a cathode, and changing the cathode before inverted to an anode, and an oxidizing agent is fed to the cathode after changed and fuel is fed to the anode after changed to carry out the restarting step of restarting the power generation.

Two sides of the membrane electrode assembly are inverted to carry out the changing operation of changing the anode before inverted to a cathode, and changing the cathode before inverted to an anode. By restarting the power generation in this state, the cathode before inverted is changed to an anode after the restarting of the power generation. This results in the potential in the cathode before inverted being lowered by using this electrode as the anode. Consequently, the power generation after inversion effects similar functions to the activation treatment. Accordingly, it can be considered that the electrochemical reduction reaction (reduction reaction of oxides of catalyst metal and adsorbed species, etc. on surfaces of catalyst) readily proceeds in the newly changed anode, namely the cathode before inverted. In contrast, the newly changed cathode, namely the anode before inverted, has been used in the positions where the electrode potential is low (nearly 0 volt relative to the standard hydrogen electrode potential) so that the formation of oxides and the adsorption of other oxygen adsorbed species are restrained, and consequently, the electrode keeps a clean surface exhibiting a high reaction activity. Therefore, where the anode is inverted to the cathode, the inverted cathode has a high reaction activity in the reduction reaction of oxygen, and exhibits high output characteristics because of the clean electrode surface. Namely, with respect to the membrane electrode assembly, the degraded output characteristics are recovered.

(2A) In accordance with a second invention, the method for operating a fuel cell which includes a cell module provided with a membrane electrode assembly having an electrolyte film, an anode and a cathode, wherein the anode and the cathode sandwich the electrolyte film and carry a catalyst metal, respectively, is characterized in that an oxidizing agent is fed to the cathode and fuel is fed to the anode to generate power, two sides of the cell module are inverted after a predetermined period of time has passed to carry out the changing operation of changing the anode before inverted to a cathode, and changing the cathode before inverted to an anode, and an oxidizing agent is fed to the cathode after changed and fuel is fed to the anode changed after the changing operation to carry out the restarting step of restarting the power generation.

By inverting two sides of the cell module provided with the membrane electrode assembly such that two sides of the membrane electrode assembly are inverted, the anode before inverted can be changed to the cathode, and the cathode before inverted can be changed to the anode. When the power generation is restarted in this state, the potential in the cathode before inverted is lowered after restarting of the power generation by using it as an anode. Consequently, the power generation after inverted effects similar functions to the activation treatment. Accordingly, it can be considered that the electrochemical reduction reaction (reduction reaction of oxides of catalyst metal and adsorbed species, etc. on surfaces of catalyst metal) readily proceeds in a new anode, namely the cathode before inverted. In contrast, a new cathode, namely the anode before inverted, has been used in the positions where the electrode potential is low (nearly 0 volt relative to the standard hydrogen electrode potential) so that the formation of oxides and the adsorption of other oxygen adsorbed species are restrained, and consequently, the electrode keeps a clean surface exhibiting a high reaction activity. Therefore, where the anode is inverted to the cathode, the inverted cathode has a high reaction activity in the reduction reaction of oxygen, and exhibits high output characteristics because of the clean electrode surface. Namely, with respect to the membrane electrode assembly, the degraded output characteristics are recovered.

(3A) In accordance with a third invention, the method for operating a fuel cell which is provided with a membrane electrode assembly having an electrolyte film, an anode and a cathode, wherein the anode and the cathode sandwich the electrolyte film and carry a catalyst metal, respectively, is characterized in that an oxidizing agent is fed to the cathode and fuel is fed to the anode to generate power, after a predetermined period of time has passed, polarities of terminals of a load to be operated by the fuel cell are inverted, and the changing operation of interchanging the oxidizing agent and fuel fed to the anode and the cathode with each other is carried out to invert the direction of an electric current generated by the fuel cell.

By carrying out the changing operation of interchanging the oxidizing agent and fuel fed to the anode and the cathode with each other, the anode before the changing operation can be changed to the cathode, and the cathode before the changing operation can be changed to the anode, similarly to the case where two sides of the membrane electrode assembly are inverted. When the power generation is restarted in the state in which the changing operation has been carried out in this way, the potential in the cathode before inverted is lowered by using it as the new anode. Consequently, the power generation after inverted has functions similar to the activation treatment. Accordingly, it can be considered that the electrochemical reduction reaction (reduction reaction of oxides of catalyst metal and adsorbed species, etc. on surfaces of catalyst metal) readily proceeds in the new anode, namely the cathode before inverted. In contrast, a new cathode, namely the anode before inverted, has been used in the positions where the electrode potential is low (nearly 0 volt relative to the standard hydrogen electrode potential) so that the formation of oxides and the adsorption of other oxygen adsorbed species are restrained, and consequently, the electrode keeps a clean surface exhibiting a high reaction activity. Therefore, where the anode is inverted to the cathode, the inverted cathode has a high reaction activity in the reduction reaction of oxygen, and exhibits high output characteristics because of the clean electrode surface. Namely, with respect to the membrane electrode assembly, the degraded output characteristics are recovered.

(Effects of Invention)

Where the performance of the fuel cell is degraded, the deterioration of the cathode can be recovered, and consequently, the method for operating the fuel cell, which is capable of recovering the performance thereof, can be provided.

### BRIEF DESCRIPTION OF DRAWINGS

FIG. 1 is a graph showing variations in cell voltage and current density before the accustomed operation, during the accustomed operation, during the activation treatment and after the activation treatment.

FIG. 2 shows a result of analysis with an AC impedance method, and is a graph showing variations in film resistance of an electrolyte film and reaction resistance of an electrode reaction before the accustomed operation, during the accustomed operation, during the activation treatment and after the activation treatment.

FIG. 3 is a system diagram relating to a first embodiment, and showing the state in which power is generated by feeding an oxidizing agent to a cathode and feeding fuel to an anode.

FIG. 4 is a system diagram relating to a first embodiment, and showing the state in which power is generated after carrying out the changing operation of changing an anode before inverted to a cathode, and changing a cathode before inverted to an anode by inverting two sides of a membrane electrode assembly.

FIG. 5 is a system diagram relating to a second embodiment, and showing the state in which power is generated by feeding an oxidizing agent to a cathode of a fuel cell module and feeding fuel to an anode thereof.

FIG. 6 is system diagram relating to a third embodiment, and showing the state in which power is generated by feeding an oxidizing agent to a cathode of a membrane electrode assembly, and feeding fuel to an anode thereof.

### BEST MODE FOR CARRYING OUT THE INVENTION

An anode and a cathode respectively carry a catalyst metal. With respect to the composition of the catalyst metal, the anode and the cathode can carry the same type of catalyst metal or identical catalyst metal to each other. With this arrangement, the interchange of the anode and the cathode by inversion, or the interchange of the supply of an oxidizing agent gas and fuel gas with each other becomes possible. The amount of the catalyst metal carried by the anode can be made similar to that carried by the cathode. Where the amount of the catalyst metal carried by the anode before inverted is relatively expressed by 100, the amount of the catalyst metal carried by the cathode before inverted can range from 75 to 125, and can especially range from 80 to 120, 90 to 110, and 95 to 105. Where the anode and the cathode are interchanged with each other by inverting the membrane electrode assembly and the fuel cell module, or where the oxidizing agent gas and the fuel gas are interchanged with each other, variations in power generation performance, which are caused by the difference in catalyst composition and amount of catalyst, can be restrained.

The catalyst metals having different compositions or different amounts may be used in the anode and the cathode according to demand.

Where gas distribution plates are provided, the pressure loss of the gas distribution plate of the anode before changed can be made on the generally same level as the pressure loss of the gas distribution plate of the cathode before changed. With this arrangement, the anode and the cathode can be readily interchanged, or the feeding of gas can be readily interchanged. Where the pressure loss of the gas distribution plate of the anode before changed is relatively expressed by 100, the pressure loss of the gas distribution plate of the cathode before inverted can range from 75 to 125, and can especially range from 80 to 120, 90 to 110, and 95 to 105. The pressure loss means the gas pressure by which the pressure of the fed gas drops while flowing from a gas inlet to a gas outlet.

(Embodiment)

(Analysis with AC Impedance Method)

The present inventor has proceeded the analysis of the activation of the fuel cell with an electrochemical AC impedance method, using a polymer electrolyte fuel cell including a plurality of membrane electrode assemblies which are layered on each other, each membrane electrode assembly having an electrolyte film, and electrodes, that is an anode and a cathode, which sandwich the electrolyte film and carry a catalyst metal, respectively, and an impedance analyzer which is also referred to as a frequency response analyzer. The electrochemical AC impedance method is a model experiment carried out in equivalent circuits wherein an electrochemical system is replaced with electric circuits. Hereinafter, a representative example of the analysis with the AC impedance method in the model experiment will be disclosed. In this case, a pure hydrogen gas (pressure: normal pressure) was fed to an anode, whereas air (normal pressure) was fed to a cathode.

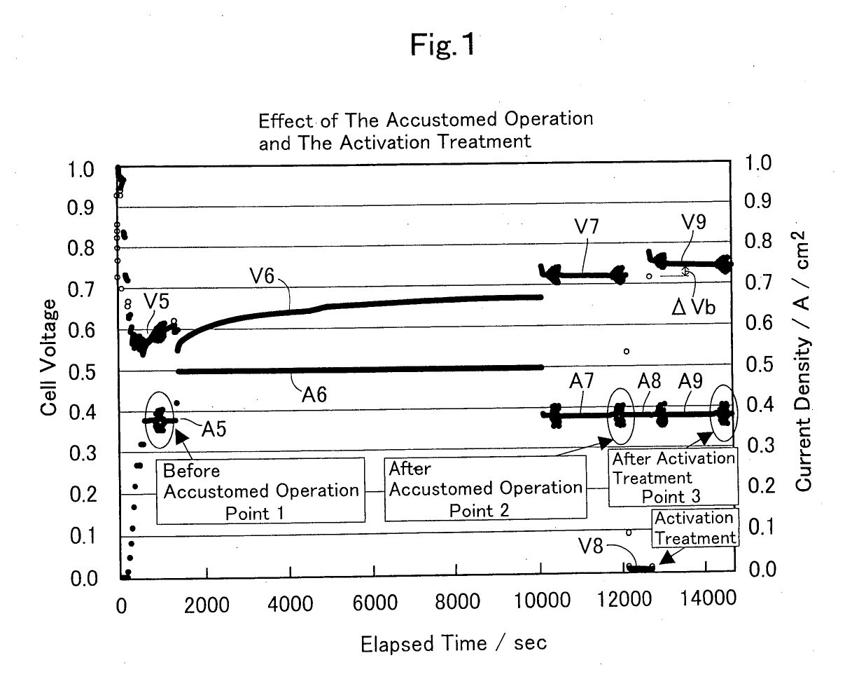

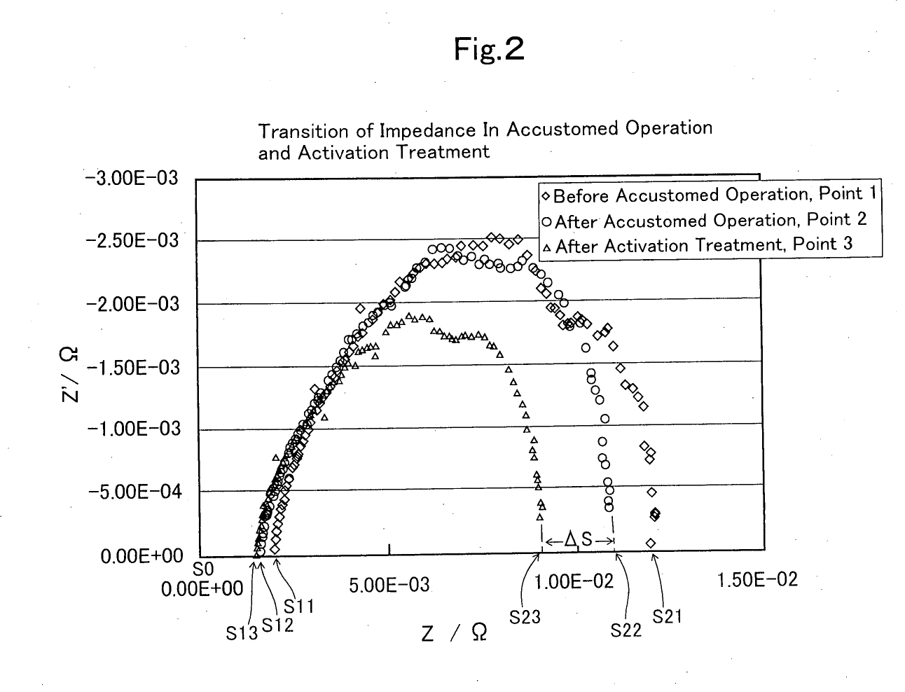

In accordance with this analysis, the accustomed operation corresponding to the prior art, and a new activation treatment developed by the present inventor were carried out in a continuous power generation operation. The analysis results are shown in FIG. 1 and FIG. 2.

In the accustomed operation corresponding to the prior art, a pure hydrogen gas (pressure: normal pressure) was fed to an anode, and air (pressure: normal pressure) was fed to a cathode to generate a great power (characteristic line A6) with a current density of 0.5 ampere/cm². The activation treatment was carried out by feeding a pure hydrogen gas (pressure: normal pressure) to the anode, feeding nitrogen gas (pressure: normal pressure) as a non-oxidizing gas to the cathode with the anode and the cathode connected electrically, determining the current density to 0.38 ampere/cm² (characteristic line A8) and lowering the potential of the cathode to about 0 volt (characteristic line V8).

In FIG. 1, the characteristic lines V5 through V9 respectively indicate a voltage, and the characteristic lines A5 through A9 respectively indicate an electric current. The characteristic line A5 and the characteristic line V5 in FIG. 1 indicate the state in which the fuel cell has started the power generation. The characteristic line A6 and the characteristic line V6 in FIG. 1 indicate the state in which the accustomed operation of the fuel cell, which corresponds to the prior art, is carried out after starting the power generation. Plots ◯ indicated in FIG. 1 are marks which are indicated when Cole-Cole Plot is prepared. The characteristic line A7 and the characteristic line V7 in FIG. 1 indicate the state in which the fuel cell carries out the power generation operation after the conventional accustomed operation thereof. The characteristic line A8 and the characteristic line V8 in FIG. 1 indicate the state in which a new activation treatment of lowering the potential of the cathode to about 0 volt (about 0.005 volt) is carried out.

When the activation treatment in which the cell voltage is determined to about 0 volt in a plus range (about 0.005 volt), as indicated by the characteristic line V8 in FIG. 1, is carried out, this cell voltage corresponds to the potential of the difference between the cathode and the anode, and since the anode is regarded as 0 volt, the cell voltage is substantially equal to the potential of the cathode.

The characteristic line A9 and the characteristic line V9 in FIG. 1 indicate the state in which the fuel cell carries out the normal power generation operation after the activation treatment. As can be understood from the comparison between the characteristic line V7 (before the activation treatment) and the characteristic line V9 (after the activation treatment) in FIG. 1, it has been confirmed that when the above-described activation treatment is carried out, the cell voltage becomes greater than that when the conventional accustomed operation is carried out by Δ Vb (see FIG. 1), and the activation effect has been recognized. According to the experiment shown in FIG. 1, the current density is as high as 0.38 ampere/cm² so that the increase of Δ Vb was observed though the cell voltage inherently has the characteristics that it is difficult to increase.

In FIG. 1, the point 1 indicates the state before the accustomed operation corresponding to the prior art. The point 2 indicates the state after the accustomed operation corresponding to the prior art, and before the activation treatment. The point 3 indicates the state after the activation treatment. Analyses of the point 1, point 2 and point 3 were carried out with the electrochemical impedance method. FIG. 2 shows the analyses results (Cole-Cole Plot) with the electrochemical impedance method, which have been indicated as a complex plane. The impedance Z in the electrochemistry is expressed as a complex amount composed of a real number component Re and a virtual number component Im, as shown by the following equation (1):
Impedance Z=R+jlm (1)

The abscissa of FIG. 2 denotes the real number component of the impedance, and the ordinate of FIG. 2 denotes the virtual number component of the impedance. “5.00E-03” indicated in the abscissa of FIG. 2 means 5.00×10⁻³. “−5.00E-04” indicated in the ordinate of FIG. 2 means −5.00×10⁻⁴. As shown in FIG. 2, before the accustomed operation corresponding to the prior art (point 1), the cell resistance corresponds to S11-S0, and the reaction resistance in the electrode reaction in the cathode corresponds to S21-S11, and the reaction resistance in the electrode reaction in the cathode was relatively great. And as shown in FIG. 2, after the fuel cell was subjected to the accustomed operation (current density: 0.5 ampere/cm²) corresponding to the prior art (point 2), the cell resistance corresponds to S12-S0, and the reaction resistance in the electrode reaction thereof corresponds to S22-S12, namely, the cell resistance and the reaction resistance in the electrode reaction became smaller than those in the point 1. This is considered to be caused by the water content of the electrolyte film gradually increasing due to the accustomed operation corresponding to the prior art of the fuel cell, thereby improving the reaction activity of the cathode.

Furthermore, as shown in FIG. 2, after the fuel cell was subjected to the new activation treatment in which the cathode was kept at about 0 volt (point 3), the cell resistance corresponds to S13-S0, and the reaction resistance in the electrode reaction thereof corresponds to S23-S13. It has been analyzed that though the cell resistance scarcely varies, the reaction resistance in the electrode reaction decreased further by Δ S.

As a result of the analyses of FIG. 1 and FIG. 2, the present inventor has found that the wetting effect of wetting the electrolyte film is effective in activating the fuel cell, too, but is not sufficient, and that for activating the fuel cell, it is effective to make the potential of the cathode as low as possible in the activation treatment, namely, to bring the potential of the cathode into the vicinity of 0 volt which is the standard electrode potential of the oxidation and reduction of hydrogen, and accordingly, the deterioration of the cathode is readily recovered. The reason for this finding has not been completely clarified, but we can consider, as follows. Namely, it is considered that as the potential of the cathode decreases, other electrochemical reduction reactions (reduction reactions of oxides of catalyst metal and adsorbed species on surfaces of the catalyst metal) readily proceed.

Accordingly, as described above, the present inventor has noticed that, at the power generation time, the potential of the cathode is high, but the potential of the anode is low (at the power generation time, the potential is low, about 0 volt), and has found that in order to lower the potential of the cathode which has been deteriorated due to the power generation reaction the following (1) through (3) are effective.
(1) Two sides of the membrane electrode assembly are inverted to change the anode before inverted to the cathode, and change the cathode before inverted to the anode (the potential at the power generation time is low, about 0 volt). This is embodiment 1.
(2) Two sides of the cell module for mounting the membrane electrode assembly are inverted to change the anode before inverted to the cathode, and change the cathode before inverted to the anode. This is embodiment 2.
(3) By interchanging the oxidizing agent and fuel to be fed to the anode and the cathode with each other, the anode before inverted is changed to the cathode, while the cathode before inverted is changed to the anode. This is embodiment 3.
   (Embodiment 1)

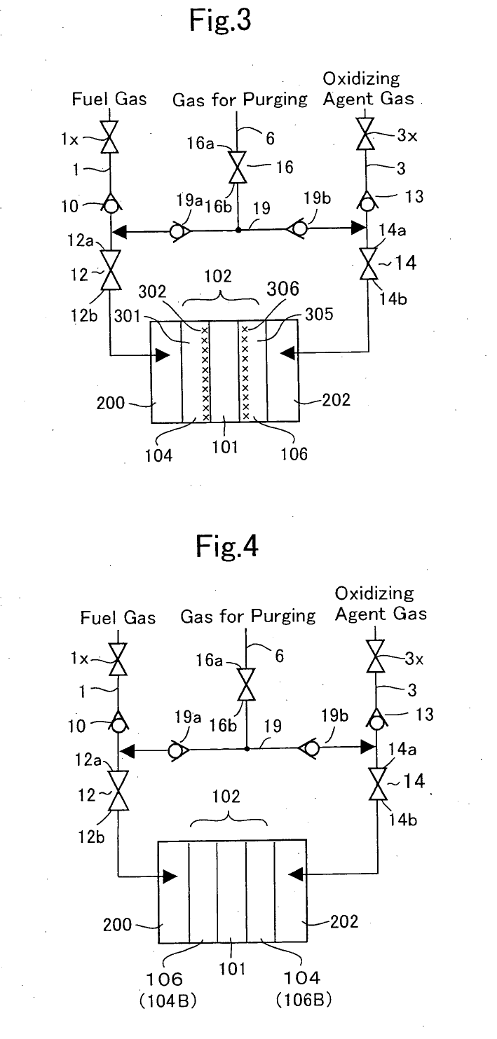

Hereinafter, the embodiment 1 of the present invention will be specifically explained with reference to FIG. 3 and FIG. 4. First, 300 g (by weight) of carbon black was mixed in 1000 g (by weight) of water to prepare a mixture liquid. The mixture liquid was stirred for ten minutes using a stirrer. 250 g of a dispersion undiluted solution (trade name: POLYFLON D1 grade) including 60 wt % of tetrafluoroethylene (hereinafter will be referred to as PTFE. manufactured by Daikin Industries, Ltd.) was added to the mixture liquid, and further stirred for ten minutes to prepare a carbon ink. A carbon paper (manufactured by Toray Industries, Inc., TorekaTGP-060, thickness: 180 μm) was thrown in this carbon ink, whereby the carbon paper was thoroughly impregnated with the above-described PTFE treating liquid. Next, excess moisture was evaporated from the carbon paper thus impregnated within a drying furnace of which the temperature was kept at 80° C., and the carbon paper was held at a sintering temperature of 380° C. for 60 minutes to sinter PTFE, thereby preparing a water-repellent carbon paper.

Next, 12 g of carbon catalyst which carries platinum with a carrying concentration of 56 wt % (manufactured by Tanaka Kikinzoku Kogyo K. K. TEC10E60E, hereinafter will be referred to as Pt/C), 106 g of an ion exchange resin solution with a concentration of 5 wt % (manufactured by ASAHI KASEI CORPORATION, SS-1080), 23 g of water, and 23 g of isopropyl alcohol as a forming auxiliary agent were thoroughly mixed to prepare a catalyst paste. This catalyst paste was applied to a fluorocarbon resin sheet with a doctor blade method to prepare a catalyst layer. Then, the catalyst layer was dried to obtain an oxidizing agent electrode sheet. In this case, the carrying amount of the catalyst metal was determined to about 0.6 mg/cm².

And, a fuel electrode sheet was prepared with a similar method. With respect to the fuel electrode sheet, the composition of the catalyst metal, and the carrying amount of the catalyst metal were respectively the same as those of the oxidizing agent electrode sheet. In this case, the fuel electrode means the anode. The oxidizing agent electrode means the cathode.

An ion exchange film with a thickness of 25 μ (manufactured by DuPont K.K. Nafion 111) was used as a solid polymer type electrolyte film. And a laminated body was formed by sandwiching a solid polymer type electrolyte film 101 with the above-described oxidizing agent electrode sheet and the fuel electrode sheet such that surfaces of catalyst layers and surfaces of the electrolyte film contact each other. Next, the laminated body was hot-pressed at 150° C., 10 Mpa, for one minute to transfer the catalyst layers on the surfaces of the electrolyte film. Then, the fluorocarbon resin sheets were peeled off the laminated body.

The solid polymer type electrolyte film was sandwiched with an anode 104 and a cathode 106 thus formed, and then, hot-pressed at 140° C., 8 Mpa, for three minutes to form a membrane electrode assembly 102 (MEA). As shown in FIG. 3, the membrane electrode assembly 102 (MEA) is composed by sandwiching the electrolyte film 101 with the cathode 104 and the anode 106.

As shown in FIG. 3, in this membrane electrode assembly 102 (MEA), the anode 104 has a porous gas diffusion layer 301 which exhibits a gas diffusion function, and a catalyst layer 302 which is formed in the gas diffusion layer 301 so as to face the electrolyte film 101 and carry the catalyst metal. The cathode 106 has a porous gas diffusion layer 305 exhibiting a gas diffusion function, and a catalyst layer 306 which is formed in the gas diffusion layer 306 so as to face the electrolyte film 101 and carry the catalyst metal. In accordance with the present embodiment, the catalyst layer in the anode 104 was made equal to that in the cathode 106 with respect to the composition of the catalyst metal and the carrying amount of the catalyst metal.

A gas distribution plate 200 for feeding fuel gas, which has a gas distribution function, was assembled so as to face the anode 104 of the membrane electrode assembly 102 (MEA), and a gas distribution plate 202 for feeding an oxidizing agent gas, which has a gas distribution function, was assembled so as to face the cathode 106, thereby composing a cell with a single cell. Power was generated using this cell. In this case, the cell temperature was 75° C., and air (utilization factor: 40%) as the oxidizing agent gas was fed to the cathode 106 as an air electrode, and a pure hydrogen gas (utilization factor: 90%) as a fuel gas was fed to the anode 104 as a fuel electrode under a normal pressure, respectively. Then, the cell voltage was determined to 0.05 volt, and after the cell was discharged with a constant potential for five minutes, a normal power generation experiment was carried out with 0.38 ampere/cm².

After 10 hours, the power generation was stopped. And a nitrogen gas was fed only to the anode 104 to carry out the nitrogen purge. The nitrogen purge is carried out to expel the fuel gas so as prevent the fuel gas from mixing with the oxidizing agent gas. The nitrogen purge means the operation of flowing nitrogen for purging, and stopping nitrogen after purging. Hereinafter, the term “nitrogen purge” will have the same meaning as the above meaning.

Then, the membrane electrode assembly 102 was turned to invert two sides thereof. As a result, as shown in FIG. 4, the anode 104 before inverted was changed to a cathode 106B, and the cathode 106 before inverted was changed to an anode 104B. And after 10 hours, only the side of the anode changed was purged with nitrogen. The reason why 10 hours are made to pass is to match the conditions to those of the comparative example corresponding to the prior art. Then, air (utilization factor: 40%) as an oxidizing agent gas was fed to the cathode 106B after changed (corresponding to the anode 104 before changed) shown in FIG. 4 under a normal pressure, and a pure hydrogen gas (utilization factor: 90%) as a fuel gas was fed to the anode 104B after changed (corresponding to the cathode 106 before changed) shown in FIG. 4 under a normal pressure. Consequently, the power generation was restarted.

And, when 10 hours have passed after restarting the power generation, the power generation was stopped, and the nitrogen purge was carried out by feeding nitrogen as a purging gas only to the anode 104B after changed. Then, the membrane electrode assembly 102 was turned again to invert the two sides thereof. After 10 hours, only the side of the anode after changed was purged with nitrogen. And the power generation was started again with the electrodes changed. By repeating these changing operations, the power generation was carried out for 500 hours in total, and an average cell potential lowering rate per hour was calculated. The average cell potential lowering rate was small, and was preferable, as compared with the later-described comparative example.

FIG. 3 and FIG. 4 show system diagrams of the embodiment 1. As shown in FIG. 3 and FIG. 4, a fuel gas passage 1, an oxidizing agent gas passage 3 and a purging gas passage 6 are provided. The fuel gas passage 1 has a valve 1x. The oxidizing agent gas passage 3 has a valve 3x. A first check valve 10 and a valve 12 are provided in the fuel gas passage 1 in series. A second check valve 13 and a second valve 14 are provided in the oxidizing agent gas passage 3 in series. A third valve 16 is provided in the purging gas passage 6. A passage 19 connecting the fuel gas passage 1, the oxidizing agent gas passage 3 and the purging gas passage 6 to each other is provided, a check valve 19a for preventing the fuel gas from flowing to the side of the oxidizing agent gas passage 3 is provided, and a check valve 19b for preventing the oxidizing agent gas from flowing to the side of the fuel gas passage 1 is provided.

At the power generating time, as shown in FIG. 3, by opening ports 12a, 12b of the first valve 12 with the purging gas passage 6 closed by closing the third valve 16, the fuel gas is fed from the fuel gas passage 1 to the anode 104 by way of the gas distributing plate 200. And by opening ports 14a, 14b of the second valve 14, the oxidizing agent gas is fed to the cathode 106 from the oxidizing agent gas passage 3 by way of the gas distributing plate 202. Thus, power generation is carried out. Upon generating power, it is required to prevent the fuel gas from mixing with the oxidizing agent gas in the membrane electrode assembly 102 and pipes. When the gas for purging (nitrogen gas) is fed from the purging gas passage 6 to the anode 104, the ports 16a, 16b of the third valve 16 are opened, and the ports 12a and 12b of the first valve 12 are opened with the feeding of the fuel gas and air stopped, and the second valve 14 closed. Consequently, the gas for purging can be fed to the anode 104 by way of the purging gas passage 6. And when the gas for purging is fed from the purging gas passage 6 to the cathode 106 before inverted, the ports 16a, 16b of the third valve 16 are opened, and the ports 14a, 14b of the second valve 14 are communicated with each other with the feeding of the fuel gas and air stopped, and the first valve 12 closed. Consequently, the gas for purging can be fed to the cathode 106 before inverted by way of the purging gas passage 6.

In the membrane electrode assembly 102 (MEA) of the present embodiment, the catalyst layer in the cathode 106 and the catalyst layer in the anode 104 are made similar to each other in composition of the catalyst metal and carrying amount of the catalyst metal. Therefore, after the changing operation of changing the anode 104 before inverted to the cathode 106B,-and changing the cathode 106 before inverted to the anode 104B is carried out by inverting two sides of the membrane electrode assembly 102, variations in power generation performance caused by the difference in composition of the catalyst and carrying amount of the catalyst before and after the changing operation are basically restrained.

Furthermore, the pressure loss in the gas distributing plate 200 and that in the gas distributing plate 202 are made similar to each other. So, after the changing operation of changing the anode 104 before inverted to the cathode 106B, and changing the cathode 106 before inverted to the anode 104B is carried out by inverting two sides of the membrane electrode assembly 102, variations in power generation performance caused by the difference in pressure loss and distribution of gas do not occur. In accordance with the present embodiment, there is no interchanging operation of passages for the fuel gas and the oxidizing agent gas, though the changing operation of inverting the two sides of the membrane electrode assembly 102 is carried out.

(Embodiment 2)

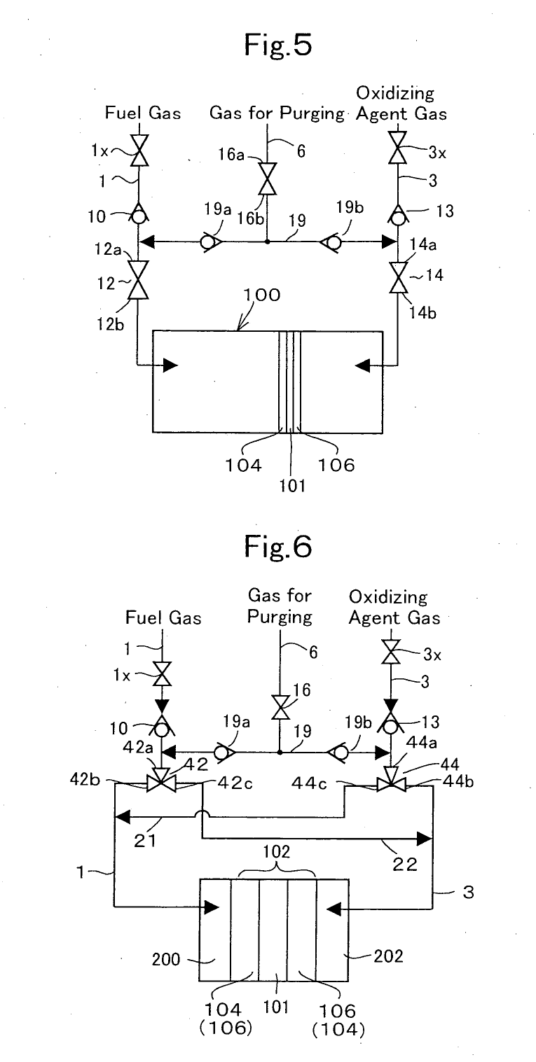

A fuel cell module 100 (see FIG. 5) was prepared by assembling a plurality of single cells, each being composed of the membrane electrode assembly 102 prepared in the embodiment 1. In the embodiment 2, the cell voltage was determined to 0.05 volt under basically similar conditions to those of the embodiment 1, and after the fuel cell module 100 was discharged with a constant voltage for five minutes, a normal power generation experiment was carried out with 0.38 ampere/cm². Power was generated by feeding air (utilization factor: 40%) as an oxidizing agent gas to the cathode 106 of the fuel cell module 100, and feeding a pure hydrogen gas (utilization factor: 90%) as fuel to the anode 104 of the fuel cell module 100. After 10 hours, the power generation by the fuel cell module 100 was stopped. And nitrogen was fed only to the anode 104 to purge the anode 104 with nitrogen. Then, the fuel cell module 100 was turned to invert two sides thereof. As a result, as shown in FIG. 4, the anode 104 before inverted was changed to the cathode 106, and the cathode 106 was changed to the anode 104.

And after 10 hours, only the side of the anode 104 after changed was purged with nitrogen. Then, air (utilization factor: 40%) as an oxidizing agent gas was fed to the cathode 106 after changed (corresponding to the anode 104 before changed) under a normal pressure, and a pure hydrogen gas (utilization factor: 90%) as a fuel gas was fed to the anode 104 after changed (corresponding to the cathode 106 before changed) under a normal pressure. Consequently, the power generation was restarted.

When 10 hours have passed after restarting the power generation, the power generation was stopped, and by feeding nitrogen only to the anode 104 after changed, the nitrogen purge of only the side of the anode 104 after changed was carried out. Then, the fuel cell module 100 was turned again to invert two sides thereof, and after 10 hours, only the anode after changed was purged with nitrogen.

And, the power generation was started again. Upon generating power, it is necessary to prevent the fuel gas from mixing with the oxidizing agent gas in the fuel cell module 100 and pipes.

By repeating these operations, the power generation was carried out for 500 hours in total, similarly to the embodiment 1, and an average cell potential lowering rate per hour was calculated. The average cell potential lowering rate in the present embodiment was small, and was preferable, as compared with a comparative example. In accordance with this fuel cell module 100, the catalyst layer in the cathode 106 and the catalyst layer in the anode 104 are made similar to each other in composition of the catalyst metal and carrying amount of the catalyst metal, similarly to the embodiment 1. The pressure loss in the gas distributing plate 200 and that in the gas distributing plate 202 are made similar to each other. Therefore, after the changing operation of changing the anode 104 before inverted to the cathode 106, and changing the cathode 106 before inverted is changed to the anode 104 is carried out by inverting two sides of the membrane electrode assembly 102, variations in power generation performance caused by the difference in composition of the catalyst metal and carrying amount of the catalyst metal before and after the changing operation are basically restrained. And variations in power generation performance caused by the difference in pressure loss of the gas, and distribution thereof are basically restrained. In accordance with the present embodiment, the changing operation of inverting two sides of the fuel cell module 100 was carried out, but there is no interchanging operation of passages for the fuel gas and the oxidizing agent gas.

(Embodiment 3)

A single cell was composed of the membrane electrode assembly 102 prepared in the embodiment 1. In the embodiment 3, under basically similar conditions to those of the embodiment 1, namely, at a cell temperature of 75° C., air (utilization factor: 40%) as an oxidizing agent gas was fed to the cathode 106 under a normal pressure, and a pure hydrogen gas (utilization factor: 90%) as a fuel gas was fed to the anode 104 under a normal pressure. And the cell voltage was determined to 0.05 volt, and after the cell was discharged with a constant potential for five minutes, a normal power generation experiment was carried out with 0.38 ampere/cm². After 10 hours, the power generation was stopped. And only the anode 104 was purged with nitrogen and the power generating step was finished. After finished, the cell was left quiet for 10 hours, nitrogen gas as a gas for purging was fed to the cathode 106, thereby carrying out the nitrogen purge. Then, the feeding of gas was interchanged between the anode 104 and the cathode 106, and the direction of an electric current was reversed. Namely, air was fed to the anode 104 before interchanged, and a pure hydrogen gas was fed to the cathode 106 before interchanged. Namely, the anode 104 before interchanged functions as the cathode 106 after interchanged. The anode 104 before interchanged functions as the cathode 106 after interchanged. As described above, by interchanging the feeding of gas between the cathode 106 and the anode 104, the direction of generated electric current was reversed. Furthermore, the polarities of a load to be driven by the power generation with the membrane electrode assembly 102 were also changed in accordance with the reversing of the direction of the electric current, and the power generation was restarted. Upon generating power, it is necessary to prevent the fuel gas from mixing with the oxidizing agent gas in the membrane electrode assembly 102 and pipes

By repeating these operations, the power generation was carried out for 500 hours in total, and an average cell potential lowering rate per hour was calculated. The average cell potential lowering rate in the present embodiment was small, and was preferable. In accordance with the present embodiment, the catalyst layer in the cathode 106 and the catalyst layer in the anode 104 are made similar to each other in composition of the catalyst metal and carrying amount of the catalyst metal, similarly to the embodiment 1. The pressure loss in the gas distributing plate 200 and that in the gas distributing plate 202 are made similar to each other. Therefore, after the feeding of gas is interchanged between the anode 104 and the cathode 106, variations in power generation performance caused by the difference in composition of the catalyst metal and carrying amount of the catalyst metal before and after interchanging of the feeding of gas are basically restrained. In addition, variations in power generation performance caused by the difference in pressure loss and distribution of gas are basically restrained.

FIG. 6 shows a system diagram of the embodiment 3. As shown in FIG. 6, a fuel gas passage 1, an oxidizing agent gas passage 3 and a purging gas passage 6 are provided. The fuel gas passage 1 has a first check valve 10 and a first three port connection valve 42. The oxidizing agent gas passage 3 has a second check valve 13 and a second three port connection valve 44. The purging gas passage 6 has a valve 16. The first three port connection valve 42 is communicated with the oxidizing agent gas passage 3 by way of a second communication passage 22. The second three port connection valve 44 is communicated with the fuel gas passage 1 by way of a first communication passage 21.

At the power generating time, by closing a port 42c and communicating ports 42a, 42b with each other, the fuel gas is fed to the anode 104 from the fuel gas passage 1 to the anode 104 by way of the gas distributing plate 200. And by closing a port 44c of the second three port connection valve 44, and communicating port 44a, 44b with each other, the oxidizing agent gas is fed to the cathode 106 from the oxidizing agent gas passage 3. When the gas for purging is fed from the purging gas passage 6 to the anode 104, the feeding of the fuel gas and air was stopped, and by closing the port 42c of the first three port connection valve 42 and opening the ports 42a and 42b of the first three port connection valve 42, the gas for purging is fed to the anode 104. And when the gas for purging is fed to the cathode 106, the feeding of the fuel gas and air was stopped, and by closing the port 44c of the second three port connection valve 44 and opening the ports 44a and 44b of the second three port connection valve 44, the gas for purging is fed to the cathode 106 by way of the gas distribution plate 202.

And when the fuel gas is fed to the cathode 106 for interchanging the gas, by closing the port 42b of the first three port connection valve 42 and opening the ports 42a and 42c, the fuel gas is fed from the fuel gas passage 1 to the cathode 106 by way of the second passage 22 and the gas distribution plate 202. And when the oxidizing agent gas is fed to the a node 104 for interchanging the gas, by closing the port 44b of the second three port connection valve 44 and opening the ports 44a and 44c, the oxidizing agent gas is fed from the oxidizing agent gas passage 3 to the anode 104 by way of the first passage 21.

(Comparative Example)

A single cell was composed of the membrane electrode assembly 102 prepared in the embodiment 1, and under the conditions substantially similar to those of the embodiment 1, the cell voltage was determined to 0.05 volt, and after the cell was discharged with a constant voltage for five minutes, a normal power generation experiment was carried out with 0.38 ampere/cm². After 10 hours, the power generation was stopped, only the anode 104 was purged with nitrogen, and the power generating step was finished. After 10 hours, the power generation was restarted. The power generation was carried out for 500 hours in total, similarly to the embodiment 1, and an average cell potential lowering rate per hour was calculated. The average cell potential lowering rate in the comparative example was comparatively greater than those of the embodiments, and was less preferable. In the comparative example, during the power generation, the anode 104 was used as the anode, and a pure hydrogen gas was fed thereto, whereas the cathode 106 was used as the cathode, and air was fed thereto. The above-described results show that the solid polymer electrolyte fuel cells of the embodiments 1 through 3 exhibit recovering properties of the power generation voltage, as compared with the comparative example, and the cell output characteristics thereof are excellent.

(Other Examples)

In accordance with the above-described embodiments, a pure hydrogen gas has been used as the fuel gas, and alternatively, a reformed gas may be used. In this case, for avoiding carbon monoxide poisoning, it is preferable to use a platinum-ruthenium-based metal as the catalyst metal in the anode 104 and the cathode 106. In accordance with the above-described embodiments, the composition and the carrying amount of the catalyst metal in the catalyst layer of the gas diffusion layer for the cathode 106 are made similar to those in the catalyst layer of the gas diffusion layer for the anode 104. But, they are not limited to the above-described conditions, and they may be made different from each other. In addition, the present invention is not limited to the embodiments disclosed above and shown in the drawings, and can be used in practice after arbitrarily modified without departing from the spirit and scope of the invention

### INDUSTRIAL APPLICABILITY

The present invention is applicable to fuel cell power generation systems for vehicles (including automobiles, tracks, buses and trains), stationary fuel cell power generation systems, portable fuel cell power generation systems, or the like.

1. A method for operating a fuel cell provided with a membrane electrode assembly which has an electrolyte film, an anode and a cathode, wherein the anode and the cathode sandwich the electrolyte film and carry a catalyst metal, respectively, comprising the steps of:
feeding an oxidizing agent to the cathode and feeding fuel to the anode to generate power;
changing the anode to a cathode, and changing the cathode to an anode after a predetermined period of time has passed; and
feeding an oxidizing agent to the cathode after changed and feeding fuel to the anode after changed, thereby starting power generation again.

2. A method for operating a fuel cell provided with a membrane electrode assembly which has an electrolyte film, an anode and a cathode, wherein the anode and the cathode sandwich the electrolyte film and carry a catalyst metal, respectively, comprising the steps of:
feeding an oxidizing agent to the cathode and feeding fuel to the anode to generate power;
inverting two sides of the membrane electrode assembly after a predetermined period of time has passed to change the anode before inverted to a cathode, and changing the cathode before inverted to an anode; and
feeding an oxidizing agent to the cathode after changed and feeding fuel to the anode after changed, thereby starting power generation again.

3. A method for operating a fuel cell including a cell module provided with a membrane electrode assembly which has an electrolyte film, an anode and a cathode, wherein the anode and the cathode sandwich the electrolyte film and carry a catalyst metal, respectively, comprising the steps of:
feeding an oxidizing agent to the cathode and feeding fuel to the anode to generate power;
inverting two sides of the cell module after a predetermined period of time has passed to change the anode before inverted to a cathode, and changing the cathode before inverted to an anode; and
feeding an oxidizing agent to the cathode after changed and feeding fuel to the anode after changed, thereby starting power generation again.

4. A method for operating a fuel cell provided with a membrane electrode assembly which has an electrolyte film, an anode and a cathode, wherein the anode and the cathode sandwich the electrolyte film and carry a catalyst metal, respectively, comprising the steps of:
feeding an oxidizing agent to the cathode and feeding fuel to the anode to generate power; and
inverting polarities of terminals of a load to be driven by the fuel cell and interchanging the oxidizing agent and the fuel fed to the anode and the cathode with each other after a predetermined period of time has passed, thereby inverting the direction of an electric current generated by the fuel cell.

5. A method for operating a fuel cell as claimed in claim 1, wherein said changing step is carried out regularly or irregularly.

6. A method for operating a fuel cell as claimed in claim 1, wherein the anode and the cathode carry an identical catalyst metal or a same type of catalyst metal, and where the amount of the catalyst metal carried by the anode before changed is relatively indicated as 100, the amount of the catalyst metal carried by the cathode before changed is determined to 75 through 125.

7. A method for operating a fuel cell as claimed in claim 1, wherein the anode before changed and the cathode before changed respectively have a gas distributing plate, respectively, and where the pressure loss in said gas distributing plate of the anode before changed is relatively expressed by 100, the pressure loss in the cathode before changed is determined to 75 through 125.

8. A method for operating a fuel cell as claimed in claim 2, wherein said changing step is carried out regularly or irregularly.

9. A method for operating a fuel cell as claimed in claim 3, wherein said changing step is carried out regularly or irregularly.

10. A method for operating a fuel cell as claimed in claim 4, wherein said changing step is carried out regularly or irregularly.

11. A method for operating a fuel cell as claimed in claim 2, wherein the anode and the cathode carry an identical catalyst metal or a same type of catalyst metal, and where the amount of the catalyst metal carried by the anode before changed is relatively indicated as 100, the amount of the catalyst metal carried by the cathode before changed is determined to 75 through 125.

12. A method for operating a fuel cell as claimed in claim 3, wherein the anode and the cathode carry an identical catalyst metal or a same type of catalyst metal, and where the amount of the catalyst metal carried by the anode before changed is relatively indicated as 100, the amount of the catalyst metal carried by the cathode before changed is determined to 75 through 125.

13. A method for operating a fuel cell as claimed in claim 4, wherein the anode and the cathode carry an identical catalyst metal or a same type of catalyst metal, and where the amount of the catalyst metal carried by the anode before changed is relatively indicated as 100, the amount of the catalyst metal carried by the cathode before changed is determined to 75 through 125.

14. A method for operating a fuel cell as claimed in claim 2, wherein the anode before changed and the cathode before changed respectively have a gas distributing plate, respectively, and where the pressure loss in said gas distributing plate of the anode before changed is relatively expressed by 100, the pressure loss in the cathode before changed is determined to 75 through 125.

15. A method for operating a fuel cell as claimed in claim 3, wherein the anode before changed and the cathode before changed respectively have a gas distributing plate, respectively, and where the pressure loss in said gas distributing plate of the anode before changed is relatively expressed by 100, the pressure loss in the cathode before changed is determined to 75 through 125.

16. A method for operating a fuel cell as claimed in claim 4, wherein the anode before changed and the cathode before changed respectively have a gas distributing plate, respectively, and where the pressure loss in said gas distributing plate of the anode before changed is relatively expressed by 100, the pressure loss in the cathode before changed is determined to 75 through 125.
